(19) United States
(12) Patent Application Publication
(10) Pub. No.: US 2016/0201388 A1
(43) Pub. Date: Jul. 14, 2016

(54) DEVICE FOR TILTING SLATS OF WINDOW BLIND

(71) Applicant: NIEN MADE ENTERPRISE CO., LTD., Taichung City (TW)

(72) Inventors: YU-CHE WEN, Taoyuan County (TW); CHING-HWA LIN, Hsinchu City (TW); HONG-YANG HSU, Hsinchu County (TW); CHAO-HUNG NIEN, Taichung City (TW); CHIEN-WEI HUANG, Taichung City (TW)

(21) Appl. No.: 14/595,301

(22) Filed: Jan. 13, 2015

(51) Int. Cl. E06B 9/322; E06B 9/38; E06B 9/30

(52) U.S. Cl. CPC E06B 9/322; E06B 9/30; E06B 9/38

(57) ABSTRACT

A tilting device is installed in a headrail of a window blind to tilt slats. The headrail includes a plurality of ladder drums and a transmission shaft. Each ladder drum is fastened with a ladder. The ladder drums are connected to the transmission shaft in series and the transmission shaft makes the ladder drums rotate. The device includes a transmission member, having a worm and a worm gear, received in the headrail and having an input shaft to engage a driven portion of the transmission shaft, and a motorizing member includes a shaft and a power source, wherein the power source powers the shaft to turn; the shaft engages the input shaft to drive the transmission shaft to turn; therefore, the window blind can be tilted by motor power or manual manipulation.

### BACKGROUND OF THE INVENTION

1. Technical Field

The present invention relates generally to a blind, and more particularly to a device for tilting slats of a window blind by motorized power or by manual manipulation.

2. Description of Related Art

A conventional window blind includes a device for tilting slats, which has a worm and a worm gear meshed with each other. The worm is connected to an end of a shaft. Ladders, which connected to the slats, are connected to the fixing cores of the shaft. The worm gear is connected to a wand. A user turns the wand to lift and lower the ladders and tilt the slats.

Typically, the wand is turned by manual manipulation, and sometime the meshed worm and gear rod are broken because of aging or stress concentration. Besides, the user has to approach the window blind to operate the wand. Sometime, it is inconvenient to the user.

### BRIEF SUMMARY OF THE INVENTION

In view of the above, the primary objective of the present invention is to provide a device for tilting slats of a window blind, which is driven by a motorized power and by manipulation.

The present invention provides a device for tilting slats of a window blind, wherein the device is incorporated in a headrail of a window blind, and the headrail further includes a plurality of ladder drums and a transmission shaft; each ladder drum handles a ladder; the ladder drums are connected to the transmission shaft in series; the transmission shaft includes a driven portion. The device includes a transmission member mounted in the headrail and having an input shaft to engage the driven portion of the transmission shaft; and a motorizing member includes a shaft and a power source, wherein the power source powers the shaft to turn; the shaft engages the input shaft to drive the transmission shaft to turn.

Therefore, the device of the present invention could be installed in an exist tilter of the window blind to make the window blind could tilt the slats with a motorized power.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the window blind of a first preferred embodiment of the present invention;

FIG. 2 is a top view of the tilting device of the first preferred embodiment of the present invention;

FIG. 3 is a perspective view of the tilting device of the first preferred embodiment of the present invention;

FIG. 4 is a perspective view of the boxes of the first preferred embodiment of the present invention;

FIG. 5 is a perspective view of the first and the second boxes of the first preferred embodiment of the present invention;

FIG. 6 is a perspective view of the third and the fourth boxes of the first preferred embodiment of the present invention;

FIG. 7 is a perspective view of the position sensor of the first preferred embodiment of the present invention;

FIG. 8 is another perspective view of the position sensor in the first preferred embodiment of the present invention;

FIG. 9 is a perspective view of the worm and the wand of the first preferred embodiment of the present invention;

FIG. 10 and FIG. 11 are perspective views of the position sensor in the first box of the first preferred embodiment of the present invention;

FIG. 12 is a perspective view of the second preferred embodiment of the present invention, showing the lever at the engaging position;

FIG. 13 is a front view of the second preferred embodiment of the present invention, in which a part of the case being removed;

FIG. 14 is a sectional view along the 14-14 line in FIG. 12; and

FIG. 15 is a sectional view similar to FIG. 14, showing the gears being disengaged;

### DETAILED DESCRIPTION OF THE INVENTION

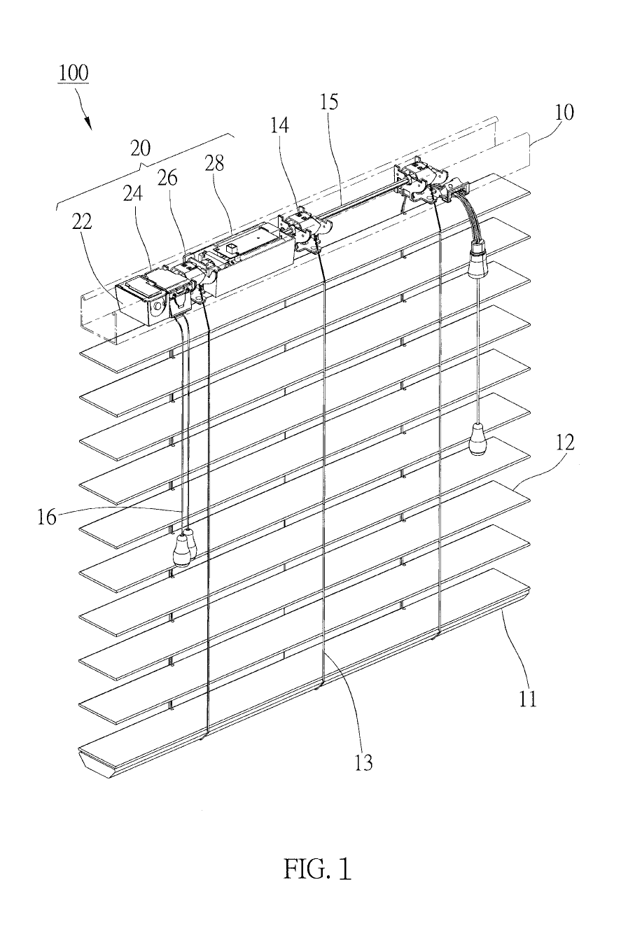

As shown in FIG. 1, it shows a window blind 100 of the first preferred embodiment of the present invention, including a headrail 10, a bottom rail 11, and a plurality of slats 12 between the headrail 10 and the bottom rail 11, a plurality of ladders 13, a plurality of ladder drums 14, and a transmission shaft 15. In the present embodiment, the ladders 13 are connected to those slats 12. Opposite ends of the ladders 13 are fastened to the bottom rail 11 and the ladder drums 14 respectively. The ladder drums 14 are received in the headrail 10 and connected to the transmission shaft 15 in series. The transmission shaft 15 is turned to lift and lower the ladders 13 that would tilt the slats 12. There elements are the same as the prior arts, which means that the present invention could be incorporated in any conventional window blind.

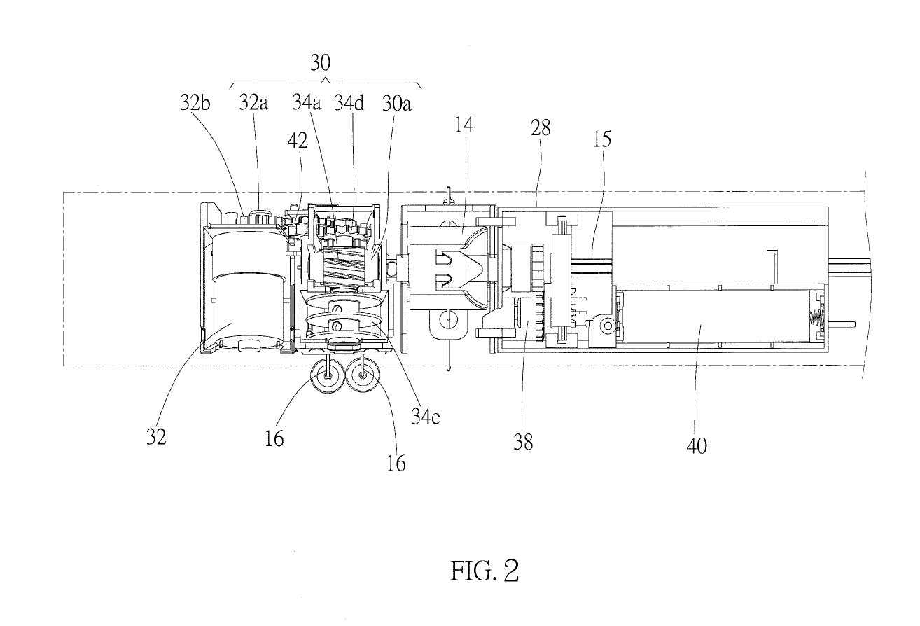

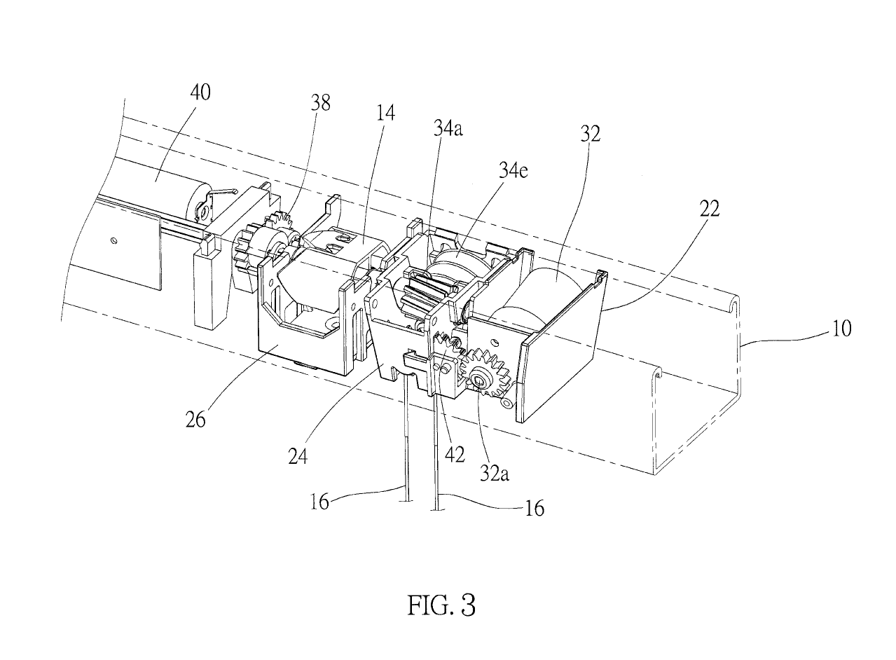

The present invention provides a tilting device 20 in the window blind 100. As shown in FIG. 2 and FIG. 3, the tilting device 20 is received in the headrail 10, and the tilting device 20 includes a first box 22, a second box 24, a third box 26, a fourth box 28, a transmission member 30, and a motorizing member. The tilting device 20 of the present invention could be driven by the motorizing member to tilt the slats 12, and the boxes 22-28 make the tilting device 20 be installed in an easy way.

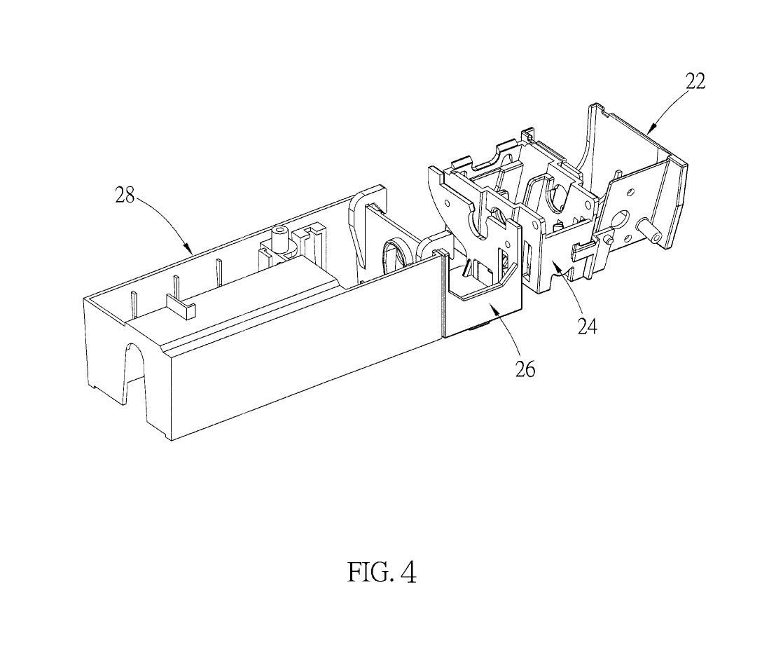

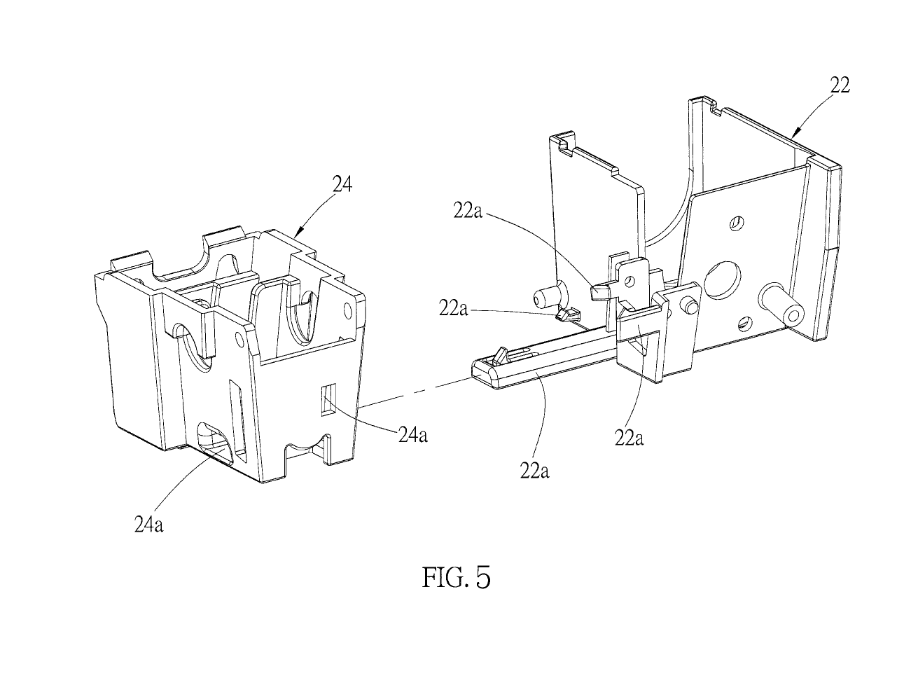

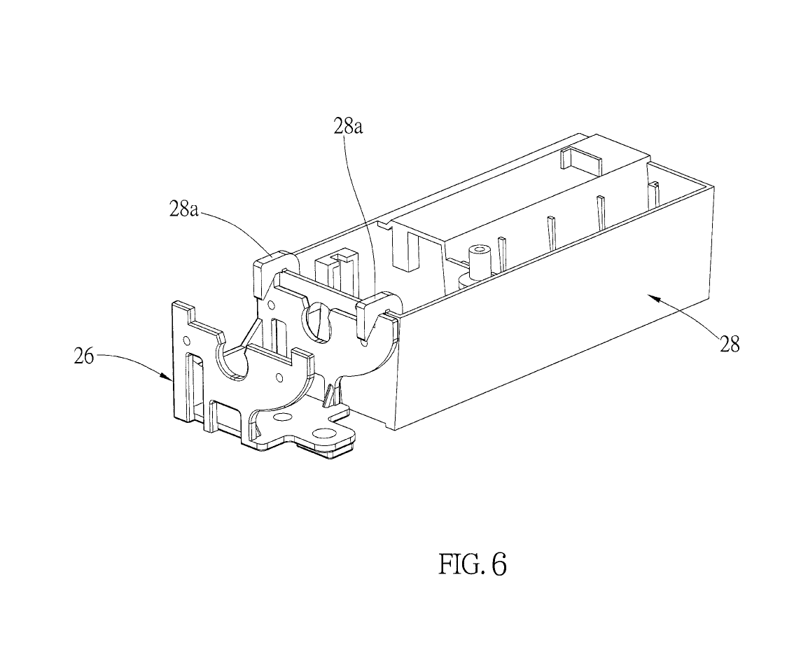

As shown in FIG. 1, the boxes 22-28 are connected in series, each of which has a specific shape and volume to receive some elements therein. As shown in FIG. 4 and FIG. 5, the first box 22 has a plurality of fasteners 22a, they have different lengths and extend in the same direction. Each fastener 22a has a hook at a distal end thereof. The second box 24 has a plurality of bores 24a, so called fastening portions. Some of the fasteners 22a of the first box 22 are directly inserted into the bores 24a on a side facing the first box 22 and engage the bores 24a with the hooks, one of the fasteners 22a extends through the second box 24 and engages the bore 24a at a back side thereof, and one of the fasteners 22a is attached on a side parallel to the fasteners 22a, and only has the hooks inserted into the bores 24a. With the engagements of the fasteners 22a and the fastening portions of the first box 22 and the second box 24 could be connected and disconnected quickly. As shown in FIG. 6, the fourth box 28 has two fasteners 28a on a side thereof and adjacent to a top. The fasteners 28a of the fourth box 28 engage a top edge of the third box 26. Lifting the fourth box 28 could separate the fourth box 28 from the third box 26.

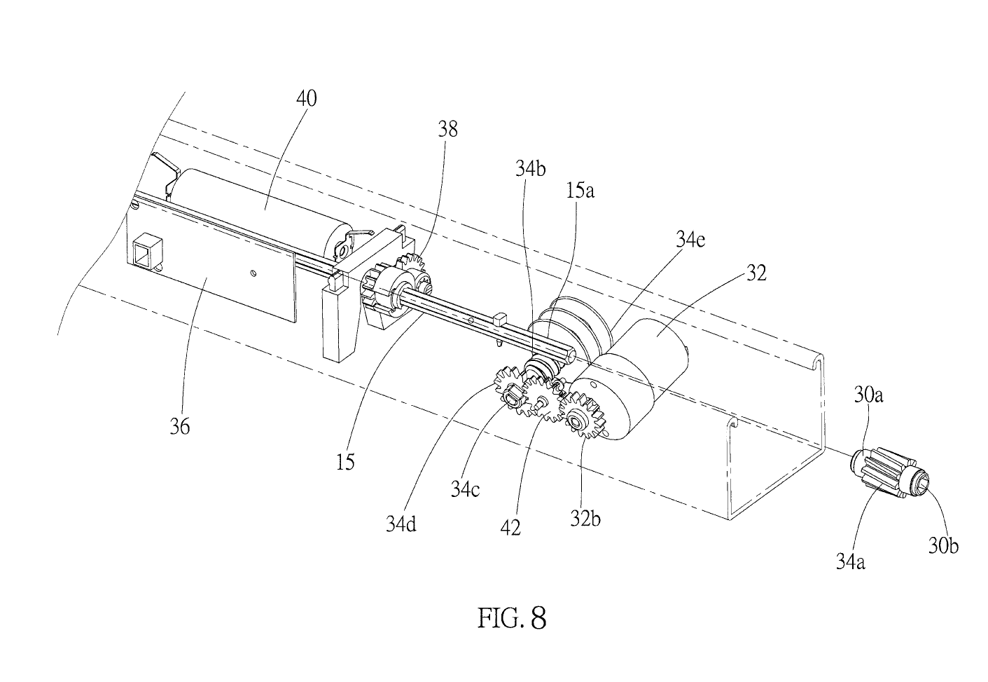

The boxes 22-28 are connected by the engagement of the fasteners and holes, so that they can be engaged and disengaged easily and quickly. Each box receives different elements therein, which means the boxes are modularized devices to be assembled in an easy way. The second, the third, and the fourth boxes 24, 26, 28 are provided with holes for the transmission shaft 15 passing through in sequence. The transmission shaft 15 has a driven portion 15a received in the second box 24 (FIG. 8). The driven portion 15a has a polygonal section in the present invention.

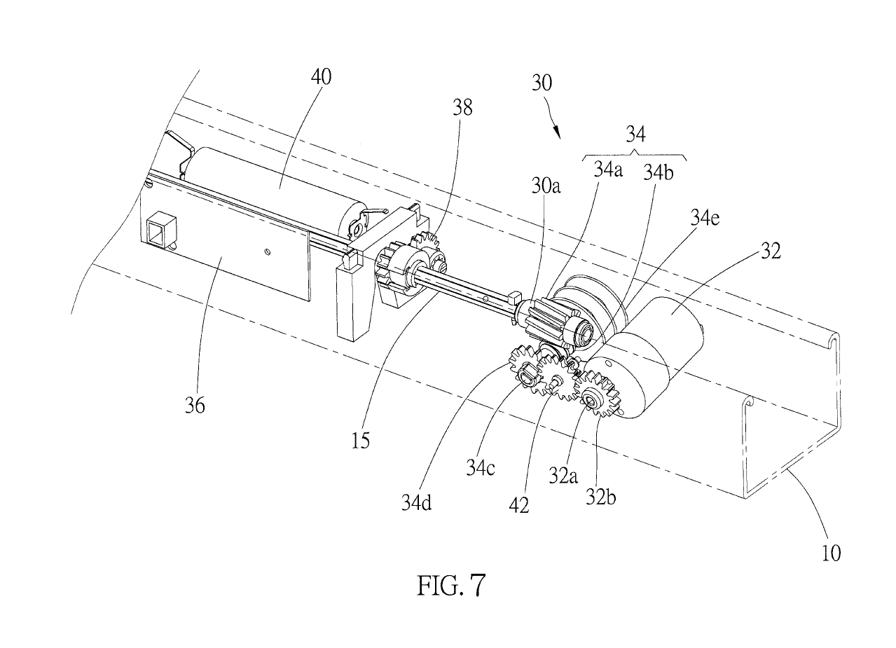

As shown in FIG. 2, FIG. 7 and FIG. 8, the transmission member 30 includes an input shaft 30a, which has a polygonal bore 30b to engage the driven portion 15a of the transmission shaft 15. The motorizing member includes a motor 32 and a power source, which includes a battery 40. The motor 32 is powered by the battery 40 to turn a shaft 32a. The shaft 32a is connected to the input shaft 30a, therefore the motor 32 could rotate the transmission shaft 15. In the present embodiment, the transmission member 30 further includes a transmission mechanism 34, and the motorizing member further includes a circuit board 36.

The motor 32 is mounted in the first box 22 to be connected to the battery 40 in the fourth box 28. The shaft 32a of the motor 32 extends out of the first box 22, and is connected to a gear 32b.

The transmission mechanism 34 is mounted in the second box 24, and includes a worm gear 34a and a worm 34b. In the present embodiment, the worm gear 34a is integrally formed with the input shaft 30a to turn along with a peripheral surface of the input shaft 30a, so that the worm gear 34a and the input shaft 30a can rotate synchronously. In another embodiment, the worm gear 34a is an independent element fixed to the input shaft 30a.

The worm 34b is meshed with the worm gear 34a, and is connected to a rod 34c. Precisely, the worm 34b is integrally formed with the rod 34c. A gear 34d is connected to an end of the rod 34c. The gear 34d is meshed with the gear 32b of the motor 32 through an intermediate gear 42, so that the worm 34b would be driven by the shaft 32a of the motor 32. Then, the worm 34b drives the transmission shaft 15 to turn through the worm gear 34a. The mesh of the worm 34b and the worm gear 34a reduces a speed of the transmission shaft 15, and the ladder drums 14 on the transmission shaft 15 would be turned slowly to lift and lower the ladders 13 and tilt the slats 12. The worm 34b provides a self-locking function to make the worm gear 34a stop the slats 12 at the desired position when the worm gear 34a is reversely turned. In an embodiment, the motor 32 is controllable by the circuit board 36 installed in the fourth box 28, and the circuit board 36 is controlled by a command with wire signal or wireless signal. It is preferred that the command is sent from a remote control with wireless signal. In another embodiment, the window blind 100 is provided with keys (not shown), which are manipulated to control the circuit board 36.

The rod 34c is provided with a reel 34e at an end opposite to the gear 34d, and two control cords 16 are fastened to the reel 34e. The control cords 16 extend out of the headrail 10 for user to pull one of the control cords 16 to tilt the slats 12 when the reel 34e and the worm 34b are turned in one direction, and pull the other control cord 16 to tilt the slats 12 when the reel 34e and the worm 34b are turned in the reverse direction. In practice, there would be only one control cord, which winds its middle section around the reel 34e and left its opposite ends out of the headrail 10 to be pulled by user, and then the reel 34e and the worm 34b are turned in the forward direction or reverse direction.

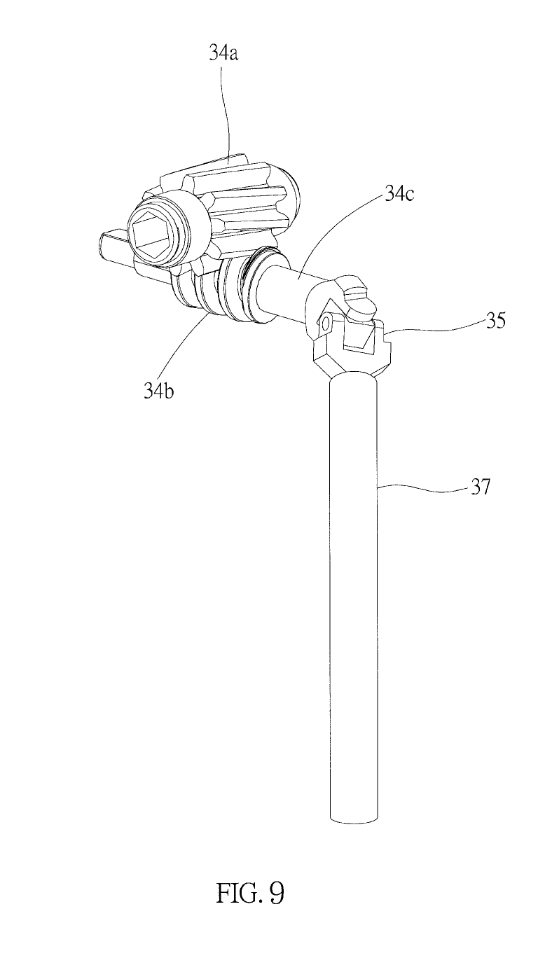

FIG. 9 shows a cordless window blind, in which a universal joint 35 for connecting the rod 34c is connected to a wand 37. The wand 37 is a replacement of the control cords 16 to be turned in both directions for tilting the slats 12 by manual manipulation. Therefore, the embodiment of the tilting device 20 can be used by manual manipulation or by motorized power.

In order to ensure a tilting angle of the slats 12, the transmission member 30 is provided with a position sensor 38 (FIG. 2). The position sensor 38 is received in the fourth box 28 and powered by the battery 40. The position sensor 38 detects a rotation angle of the transmission shaft 15, which indicates the real tilting angle of the slats 12. By stopping the transmission shaft 15 at a predetermined angle, it may tilt the slats 12 with a predetermined tilting angle.

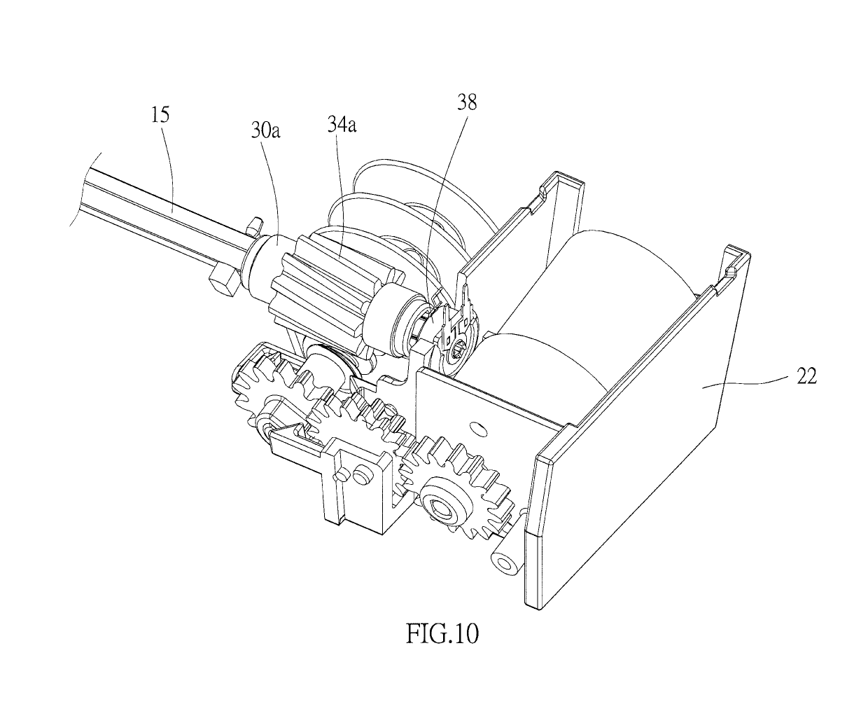

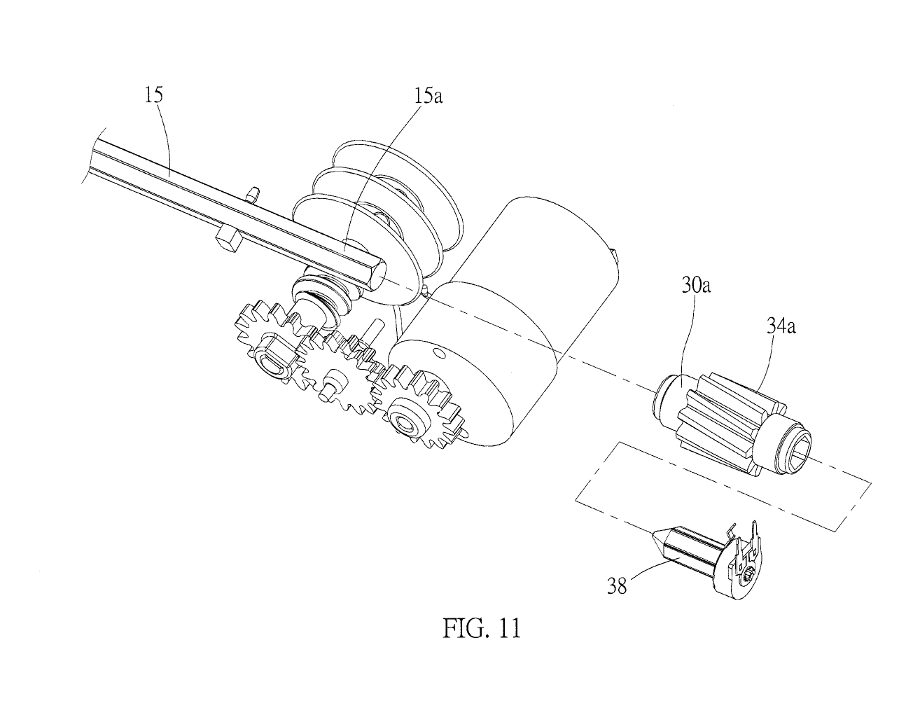

As shown in FIG. 10 and FIG. 11, the position sensor 38 is received in the first box 22 instead of the fourth box 28. The same as above, the driven section 15a of the transmission shaft 15 is received in the second box 24, the input shaft 30a engages the driven section 15a, and the worm gear 34a is connected to the input shaft 30a, so the worm gear 34a can rotate with the input shaft 30a synchronously. The position sensor 38 is connected to the input shaft 30a at an end opposite to the transmission shaft 15. With this arrangement, it may obtain the real angle of the slats 12.

As described above, the transmission mechanism 34 in the second box 26 and the ladder drum 14 in the third box 26 are the main in the conventional tilting device. In other words, the present invention provides the motor 32 in the fourth box 28 and the battery 40 and the circuit board 36 in the first box 22 to make the tilting device be driven by the motor 32. The modularized design of the present invention converts the conventional tilting device into the tilting device of the present in an easy way. The present invention provides a solution to convert a manual blind into a motorized blind by connecting the first box 22, in which the motor 32 is received, to the second box 24 and the third and the fourth boxes 26, 28, which receive the circuit board 36 and the battery 40. The present invention also provides the position sensor 38 in the first box 22 (or in the fourth box 28). It may obtain a motorizing module to be installed in the headrail of the window blind. With the present invention it may convert a manual blind into a motorized blind with a low cost to increase the value of the blind.

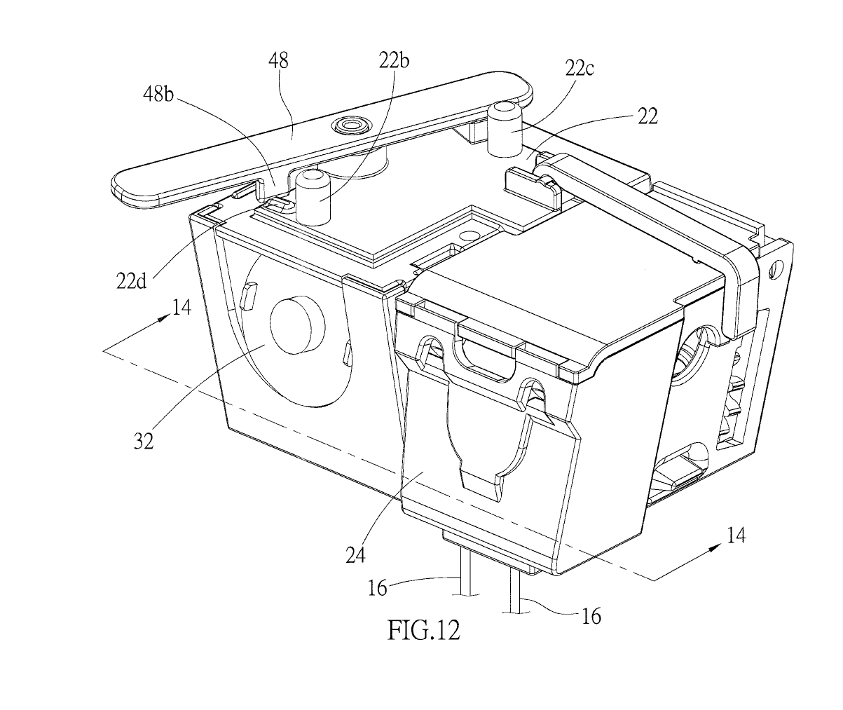

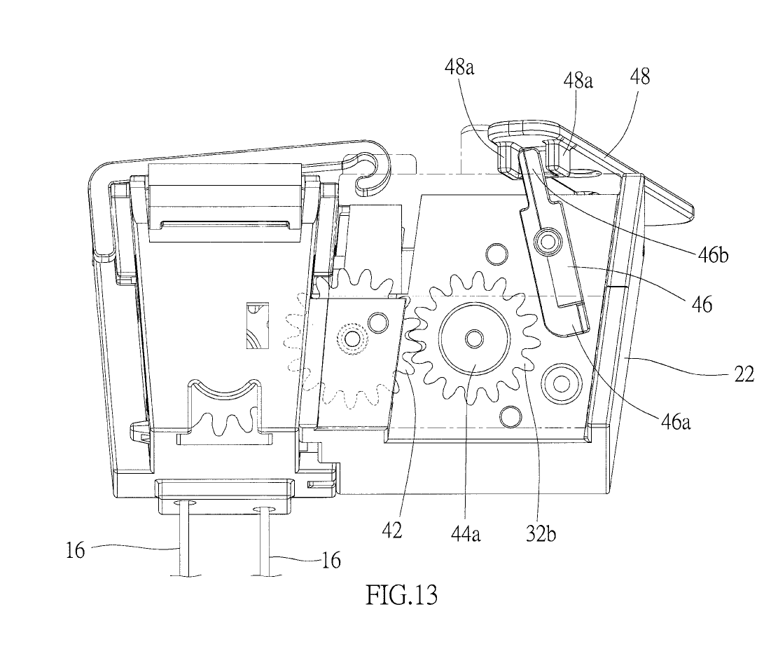

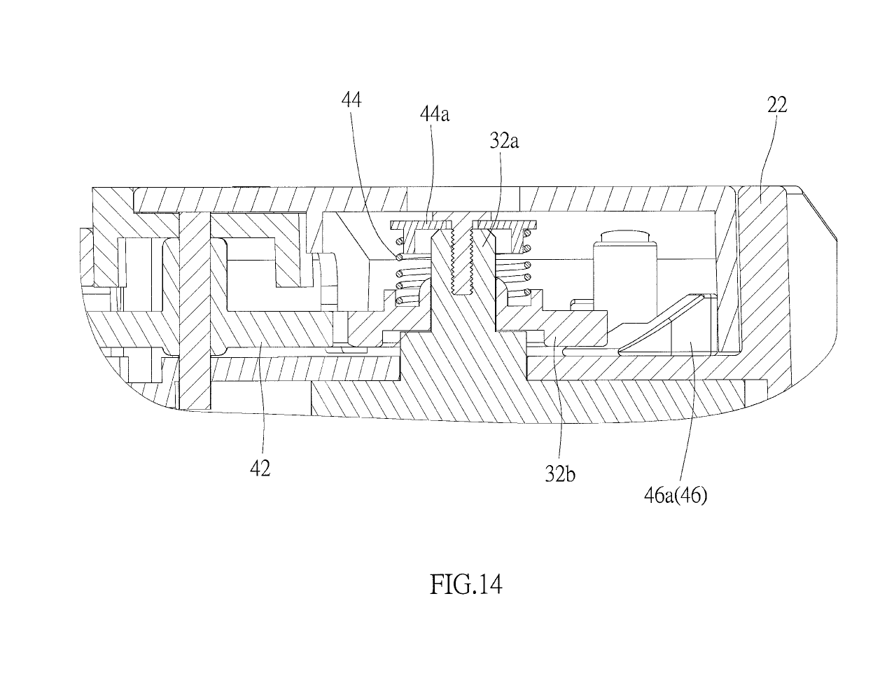

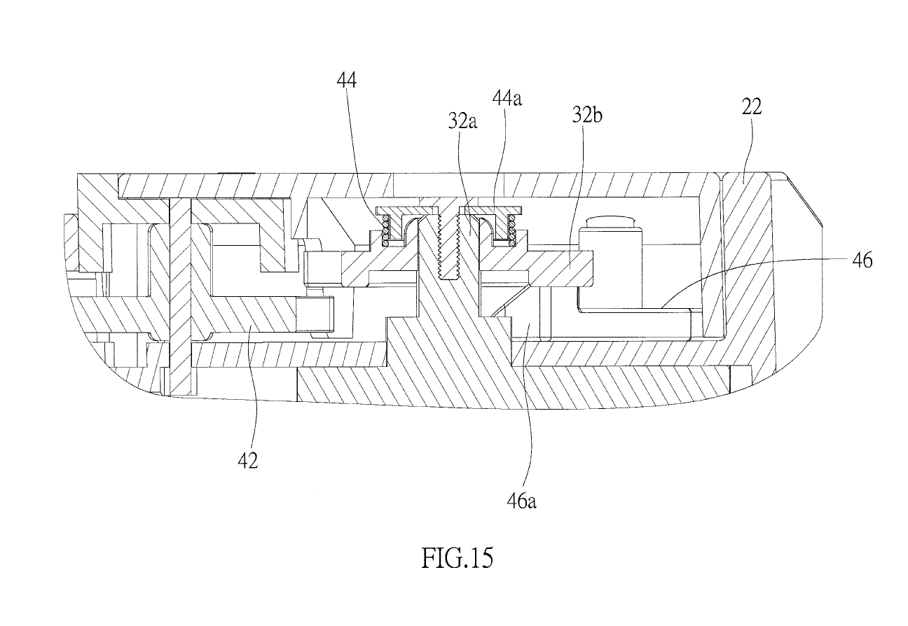

FIGS. 12-15 show the second preferred embodiment of the present invention, in which a new design is put on the first box 22. As shown in FIG. 14 and FIG. 15, the gear 32b is connected to the shaft 32a of the motor 32, and moves along the shaft 32a between a first position (FIG. 14) and a second position (FIG. 15). A spring 44 is fitted to the shaft 32, and then a cap 44a is fixed to the shaft 32 by a bolt. The spring 44 has opposite ends urging the cap 44a and the gear 32b to move the gear 32b toward the first position. In the first position, as shown in FIG. 14, the gear 32b engages the intermediate gear 42, and in the second position, as shown in FIG. 15, the gear 32b disengages the intermediate gear 42. The second preferred embodiment further includes a first lever 46 and a second lever 48. As shown in FIGS. 12 and 13, the first lever 46 is pivoted on an inner side of the first box 22, and has a driving portion 46a at an end in association with the gear 32b and a driven portion 46b at the other end. The driving portion 46a has a tapered block, and the driven portion 46b extends out of the first box 22. The second lever 48 is pivoted on an outer side of the first box 22, and is perpendicular to the first lever 46. The second lever 48 has a driving portion 48a at an end in association with the driven portion 46b of the first lever 46. In the present embodiment, the driving portion 48a has two protrusions, and the driven portion 46b of the first lever 46 is between the protrusions. Moving a free end of the second lever 48 will move the gear 32b through moving the first lever 46. As shown in FIG. 14, the driving portion 46a of the first lever 46 keeps a distance from the gear 32b, and the spring 44 forces the gear 32b staying at the first position to engage the intermediate gear 42. When the second lever 48 is moved, the first lever 46 is moved by the second lever 48 to have the driving portion 46a entering a space behind the gear 32b. The tapered block of the driving portion 46a will move the gear 32b to the second position (FIG. 15) to disengage the intermediate gear 42.

The second preferred embodiment provides a manual switch for user to turn on tilting device 20 or turn off by engaging and disengage the gear 32b with the intermediate gear 42. As shown in FIG. 12, the first box 22 is provided with two posts 22b, 22c to stop a swinging range of the second lever 48. The second lever 48 further is provided with a plate 48b, and the first box 22 is provided with a protrusion 22d. The plate 48b will be flexed and cross over the protrusion 22d when the second lever 48 is moved to restrict the second lever 48, and as a result, the gear 32b is restricted at the first and the second positions. With the design of above the user may tilt the slats by motorized power when the gear 32b is engaged with the intermediate gear 42. The present invention also may be converted into manual mode by moving first lever 46 is moved to disengage the gear 32b with the intermediate gear 42. In the manual mode the user may manually pull the control cords 16 to tile the slats through the transmission mechanism 34 (FIG. 2). It is noted that the gear 32 will not be driven to turn in the manual mode to make the user may pull the control cords 16 in an easy way.

It must be pointed out that the embodiments described above are only some preferred embodiments of the present invention. All equivalent structures which employ the concepts disclosed in this specification and the appended claims should fall within the scope of the present invention.

What is claimed is:

1. A device, received in a headrail of a window blind, for tilting slats of said window blind, wherein the headrail includes a plurality of ladder drums and a transmission shaft; each ladder drum is fastened with a ladder; the ladder drums are connected to the transmission shaft in series; the transmission shaft includes a driven portion, comprising:
a transmission member received in the headrail and having an input shaft to engage the driven portion of the transmission shaft; and
a motorizing member includes a shaft and a power source, wherein the power source powers the shaft to turn; the shaft engages the input shaft to drive the transmission shaft to turn.

2. The device of claim 1, wherein the motorizing member further includes a motor, and the transmission member further includes a transmission mechanism; the motor is beside the driven portion of the transmission shaft, and electrically connected to the power source; the shaft is connected to the motor; the transmission mechanism is between the input shaft and the shaft, and includes a worm gear and a worm meshed with each other; the worm gear is connected to the input shaft, and the worm is driven by the shaft.

3. The device of claim 2, wherein the worm is connected to a rod, and a reel is connected to the rod of the worm; two control cords are fastened to the reel, whereby the reel is turned in a direction when one of the control cords is pulled, and the reel is turned in a direction when the other control cord is pulled.

4. The device of claim 2, wherein the worm gear is formed with the input shaft integrally, and the input shaft is provided with a polygonal bore; the driven portion of the transmission shaft has a polygonal section, which is correspondingly inserted into the polygonal bore of the input shaft.

5. The device of claim 2, further comprising a first box, in which the motor is received, and a second box, in which the transmission mechanism is received, wherein the first box is provided with at least a fastener, and the second box is provided with at least a fastening portion; the first box and the second box are connected together by an engagement of the fastener and the fastening portion.

6. The device of claim 2, wherein the motorizing member further includes a position sensor, which is powered by the power source to detect a rotation angle of the transmission shaft.

7. The device of claim 6, further comprising a third box, in which the ladder drum is received, and a fourth box, in which the power source and the position sensor are received, wherein the fourth box is provided with at least a fastener, and the fourth box is connected to the third box by engaging the fastener with the third box.

8. The device of claim 5, wherein the motorizing member further includes a position sensor, which is powered by the power source to detect a rotation angle of the transmission shaft.

9. The device of claim 8, further comprising a third box, in which the ladder drum is received, and a fourth box, in which the power source and the position sensor are received, wherein the fourth box is provided with at least a fastener, and the fourth box is connected to the third box by engaging the fastener with the third box.

10. The device of claim 1, wherein the motorizing member further includes a motor and a circuit board; the motor and the circuit board are electrically connected to the power source respectively; the motor is beside the driven portion of the transmission shaft, and the shaft is connected to the motor; the circuit board controls the motor by receiving a command.

11. The device of claim 2, wherein the worm includes a rod, and the rod of the worm is connected to a wand through an universal joint, whereby the wand is manipulated to turn the rod.

12. The device of claim 1, further comprising a first lever having a driving portion, wherein the shaft of the motorizing member engages the input shaft of the transmission member through a gear and an intermediate gear, and the gear is moved between a first position, in which the gear engages the intermediate gear, and a second position, in which the gear disengages the intermediate gear; the first lever is moved to have the driving portion moving the gear from the first position to the second position.

13. The device of claim 12, further comprising a spring urging the gear toward the first position.

14. The device of claim 12, wherein the driving portion of the first lever has a tapered block entering a space behind the gear when the first lever is moved to move the gear from the first position to the second position.

15. The device of claim 12, further comprising a second lever having an end engaging an end of the first lever, whereby moving the first lever is moved when the second lever moves.

16. The device of claim 15, wherein the second lever is provided with two protrusions, and the end of the first lever is received in a space between the protrusions.

17. The device of claim 15, wherein a first box is provided with two posts, and the second lever abuts against the posts respectively when the second lever is moved.

18. The device of claim 15, wherein a first box is provided with a protrusion, and the second lever is provided with a plate; the plate is flexed and crosses the protrusion when the second lever is moved.
